(19) United States
(12) Patent Application Publication
(10) Pub. No.: US 2002/0148127 A1
(43) Pub. Date: Oct. 17, 2002

(54) Multi-configurational carpentry tool

(76) Inventors: Troy Dana, Draper, UT (US); Oscar Monroe Merriman, West Valley, UT (US)

Correspondence Address: Troy Dana, 1516 East Cherry Creek ln., Draper, UT, 84020, US

(21) Appl. No.: 10/125,741

(22) Filed: Apr. 16, 2002

Related U.S. Application Data
(60) Provisional application No. 60/284,292, filed on Apr. 16, 2001.

(51) Int. Cl. B43L 7/10

(52) U.S. Cl. 33/456

(57) ABSTRACT

A carpentry tool for defining a plurality of measuring configurations is disclosed. The tool has a frame and an arm, where the arm is rotatably and slidably coupled to the frame. The frame may also include a collapsible rule and at least one bubble level. The members of the tool may also include various measuring indicators and angle indicators. The combination of the frame, the arm, the collapsible rule, and the bubble level allow the tool to be positioned in multiple measuring configurations.

### RELATED APPLICATION

This application is related to and claims the benefit of U.S. Provisional Patent Application Serial No. 60/284,292 of Troy Dana and Oscar Merriman, filed Apr. 16, 2002 and entitled “M2 Square by Merriman Tools, L.C.” which is incorporated herein by reference.

### BACKGROUND OF THE INVENTION

1. Field of the Invention

The present invention relates to carpentry tools. More particularly, the present invention relates to a carpentry tool that is capable of being positioned in a plurality of measuring configurations.

2. Technical Background

A large number of tools are currently available for various carpentry applications. Multiple tools have been developed for most applications that may be encountered during a project. Often, multiple tools are needed to complete a single project. However, investing in a large number of tools can be expensive and traveling to a hardware store to purchase a new tool during a project can waist valuable time. Additionally, carrying a large number of tools to and from a project can be cumbersome and can increase the possibility of loosing a tool. Tools may also become scattered about the work area,

The tool is comprised of a frame having a first end and a second end, where an arm is rotatably and slidably coupled to the first end of the frame. By positioning the arm relative to the frame, a plurality of measuring configurations may be achieved. The tool may include a collapsible rule coupled to the second end of the frame. The collapsible rule may fold into smaller rule sections. The frame may also include at least one bubble level in the frame. The frame may have a horizontal bubble level, a vertical bubble level, and a 45° bubble level.

The frame, arm, and collapsible rule may include a plurality of measuring indicators creating multiple measuring configurations. The tool may also have angle indicators to define the relative orientation of the arm to the frame. The positioning of the arm and the collapsible rule may be fixed by a clamping mechanisms attached to the frame.

The arm may have an elongated slot that is attached to a mounting pin of the frame and that is situated in the elongated slot. The rotation of the arm relative to the frame may be limited by the presence of a stop in the frame. The frame may also include an arm recess and a rule recess to allow the arm and the rule to be nested into the frame when not in use.

These and other features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and features of the invention are obtained, a more particular description of the invention summarized above will be rendered by reference to the appended drawings. Understanding that these drawings only provide selected embodiments of the invention and are not therefore to be considered limiting in scope, the invention will be described and explained with additional specificity and detail through the use of the accompanying drawings in which:

FIG. 1 is a perspective view of a multi-configurational tool.

FIG. 2 is another perspective view of the multi-configurational tool.

FIG. 3 is a side view of the angle indicators on the frame.

### DETAILED DESCRIPTION OF THE PREFERRED EMBODIMENTS

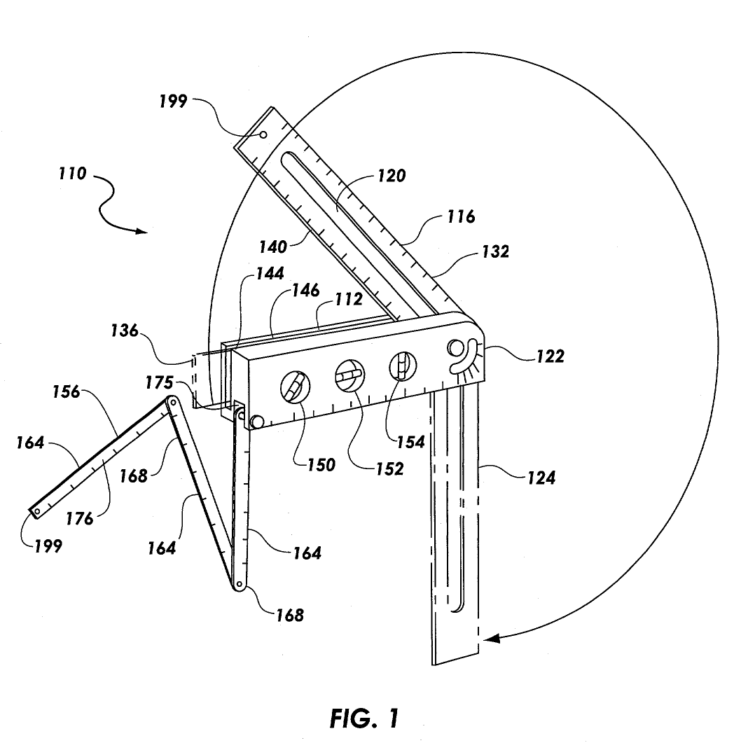

The preferred embodiments of the invention are now described with reference to FIGS. 1-3, where like reference numbers indicate identical or functionally similar elements. The members of the present invention, as generally described and illustrated in the Figures, may be implemented in a wide variety of configurations. Thus, the following more detailed description of the embodiments of the system and method of the present invention, as represented in the Figures, is not intended to limit the scope of the invention as claimed, but is merely representative of presently preferred embodiments of the invention.

The present invention provides a multi-configurational tool that is adjustable to define a plurality of measuring configurations. The tool is generally lightweight and compact, allowing for easy transport and handling while performing various carp entry functions. The tool replaces multiple tools that would otherwise be required for the various functions, thus increasing efficiency and safety.

Referring now to FIG. 1, a perspective view of the tool 110 is illustrated. The tool 110 is comprised of a frame 112 and an arm 116, where the arm 116 is rotatably and slidably coupled to the frame 112. The frame 112 may be a generally rectangular shaped structure made of a metal, plastic or other similar rigid material. Likewise, the arm 116 may be made of a thin metal or plastic material. Generally, the arm 116 may be made of any material that is commonly used in the manufacture of rulers or other similar measuring devices.

In one embodiment, the arm 116 has a generally elongated slot 120 along its length. The slot 120 allows the arm 116 to be attached to the frame 112 by a mounting pin (not shown) at the first end 122 of the frame 112. The mounting pin slides along the elongated slot 120 as the arm 116 is moved relative to the frame 112. The mounting pin and the elongated slot also allow the arm 116 to pivot relative to the frame 112. Thus, by locating the mounting pin in the slot 120, the arm 116 may be rotatably and slidably coupled to the frame 112.

Alternatively, other mechanisms other than an elongated slot 112 and a mounting pin may be used in the tool to allow the arm 116 to be rotatably and slidably coupled to the frame 112. In one variation, the arm 116 may have a track and the frame 112 may have a guiding wheel. The guiding wheel may translate and pivot inside the track, allowing the arm 116 to slide and rotate relative to the frame 112. Other configurations of the arm 116 and the frame 112 may be incorporated into the present tool 110, so long as the configurations allow the arm 116 to be rotatably and slidably coupled to the frame 112.

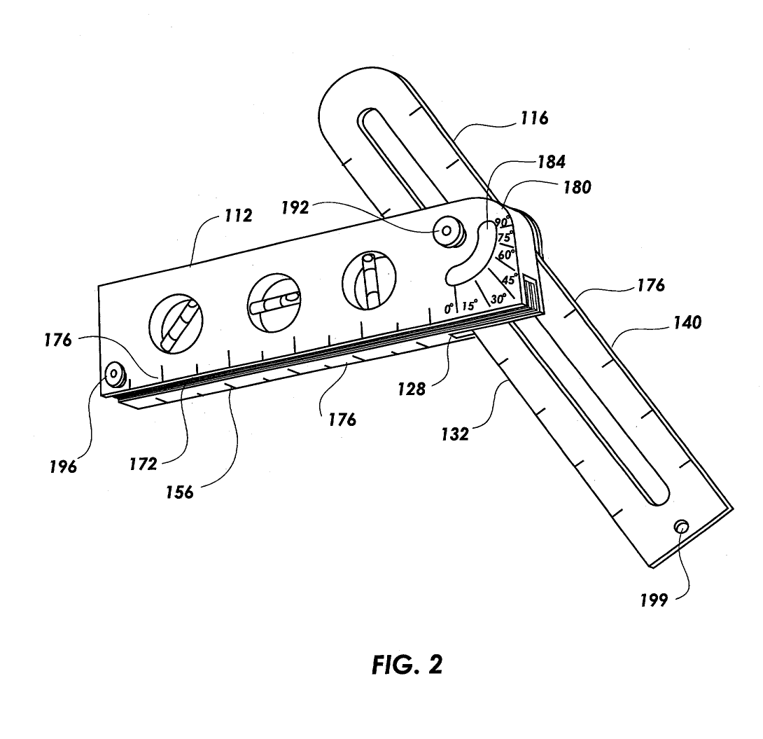

In one embodiment of the tool 110, the arm 116 may have a large range of pivotal motion relative to the frame 112. The arm 116 may have the 270° rotation. The first limit of the rotation 124 may be created by a stop 128, visible in FIG. 2, which engages the leading edge 132 of the arm 116 at the first limit of rotation 124. The stop 128 may be a simple lip or abutment in the frame 112 that comes in contact with the leading edge of 132 of the arm 116. The stop 128 may be configured such that when the arm 116 is at the first limit of rotation 124, the frame 112 and the arm 116 create a 90° angle.

The second limit of rotation 136 occurs at the location where the trailing edge 140 of the arm 116 abuts the frame 112. In one embodiment, the frame 112 has an arm recess 144 that is sized to receive the arm 116. The arm recess 144 may be a slot in the frame 112 that has a width generally equal to or greater than the width of the arm 116. In one configuration, it may be desirable for the depth of the arm recess 144 to be substantially equal to the width of the arm 116. Such a configuration, would allow a substantial portion of the arm 116 to nest into the body of the frame 112. Thus, the frame 112 could have a flush upper surface 146, without portions of the arm 116 extending above the surface of the frame 112.

The length of the arm recess 144 may be equal to the length of the frame 112. However, the length of the arm 116 may be longer than the length of the frame 112. As such, a portion of the arm 116 may extend out from the edge of the frame 112. When the arm 116 nests into the arm recess 144, the trailing edge 140 abuts the bottom of the arm recess 144, defining the second limit of rotation 136.

The 270° rotation of the arm 116, between the first limit of rotation 124 and the second limit of rotation 136, allows the arm 116 to be positioned in multiple orientations relative to the frame 112. The rotation of the arm 116 into the arm recess 144 allows the tool 110 to be compact and portable. Furthermore, the arm 116 may have other ranges of rotation besides 270°, depending on the application.

The frame 112 may also include at least one bubble level 150, 152, 154. In the embodiment illustrated in FIG. 1, the frame has a 45° bubble level 150, a horizontal bubble level 152, and a vertical bubble level 154. The use of three bubble levels 150, 152, 154 allows the frame 112 to functions similarly to a torpedo level. However, the frame 112 may have more than or less than three bubble levels 150, 152, 154 depending upon the desired application.

The frame 112 may also include a plurality of openings corresponding to the number of bubble levels 150, 152, 154. The openings allow the bubble levels 150, 152, 154 to be viewed from either side of the frame 112. Furthermore, the openings allow light to pass through the bubble levels 150, 152, 154 to increase the visibility of the bubble.

In addition to the bubble level 150, 152, 154, the frame 112 may also include a collapsible rule 156 coupled to the frame 112. The collapsible rule 156 may be rotatably attached to the frame 112. The rotatable attachment of the rule 156 may be achieved by any number of rotational attachment mechanisms, such as a pin joint. In one embodiment, the collapsible rule 156 may rotate about 90°.

The collapsible rule 156 may be made of a plurality of smaller rule segments 164 separated by folding joints 168. The folding joints 168 may have multiple stable positions, such that the smaller rule segments 164 may snap into a generally straight alignment. In the straight alignment, the collapsible rule 156 may pivot relative to the frame 112.

In one configuration, the folding joints 168 may snap into alignment through a dimple and hole interaction. At a first stable position, dimples on a first rule segment 164 will be positioned in corresponding holes in a second rule segment 164. As the first and second rule segments 164 are rotated relative to one another, the dimples will slide out of the holes. The dimples and holes may be biased together by a spring or other similar biasing mechanism, causing the dimples and holes to resist disengagement. As the rule segments 164 rotate, the dimples will drop in two different holes, creating multiple stable positions. In one embodiment, the smaller rule segments 164 may have two stable positions that are 180° offset, corresponding to a folded and unfolded configuration.

Another variation of the collapsible rule 156 may include multiple small rule segments 164 that slide together, similar to sliding together multiple sections of a ladder. For example, the collapsible rule 136 may include three smaller rule segments 164. The three smaller rule segments 164 may slide together, such that the three smaller rule segments 164 are equal to the length of a single small rule segment 164.

Once the collapsible rule 156 is in the folded configuration, the collapsible rule 156 may be nested into a rule recess 172. The rule recess 172 is a slot in the frame 112 that is sized to receive the collapsible rule 156. The recess 172 is similar to the arm recess 144, in that the rule recess 172 allows the collapsible rule 156 to be nested into the frame 112. Thus, when the collapsible rule 156 is not being used, it may be stored in a location where the collapsible rule 156 will not interfere with the operation of other functions of the tool 110.

The different members of the tool 110 may include various measuring indicators 176. Referring to FIG. 2, the frame 112 may include measuring indicators 176 located along the length of the frame 112. The measuring indicators 176 may be on the faces or on the sides of the frame to allow measuring in different orientations of the tool 110. The measuring indicators 176 on the frame 112 may include both standard and metric measuring units. The measuring indicators 176 may also be divided into various sub-units, such a centimeters, millimeters, fractions of inches, tenths of inches, etc.

Similar measuring indicators 176 may also be placed on the arm 116. The arm 116 may have measuring indicators 176 along each of the edges 132, 140 and on either side of the arm 116. The measuring indicators 176 on the different locations of the arm 116 may have different measuring indicator 176 configurations. For example, the leading edge 132 of the arm 116 may have measuring indicators 176 with ascending values that increase from the attachment location with the frame 112. Alternatively, the trailing edge 136 may include measuring indicators 176 with descending values. Additionally, the different edges 132, 136 may each have different measuring systems, such as one having standard measuring indicators 176 and the other having metric measuring indicators 176.

Furthermore, the measuring indicators 176 may have varying beginning points along the length of the arm 116 to allow for the different measuring configurations of the tool 110. In one embodiment, the measuring indicators 176 located on the arm 116 may begin or restart at a determined distance from the edge of the arm 116. This distance, may correspond to a different position of the arm 116 relative to the frame 112. Because the elongated slot 120 of the arm 116 may slide along the mounting pin of the frame 112 from side to side, different ends of the arm 116 may align to the frame 112. Thus, it may be desirable for the measuring indicators 176 to have beginning values that correspond to the different alignments of the arm 116 to the frame 112.

Referring again to FIG. 1, the collapsible rule 156 may also have a plurality of measuring indicators 176. The measuring indicators 176 may be in standard or metric measuring units. Additionally, the collapsible rule 156 may include different measuring indicators 176 on each of the edges and on either side of the collapsible rule 156. The measuring indicators 176 may also have various beginning values along the length. For example, the measuring indicators 176 of the collapsible rule 156 may be a continuation of the measuring indicators 176 of the frame 112. Thus, the edge of the frame 112 to the edge of the unfolded collapsible rule 156 may be one generally long measuring length.

The measuring indicators 176 may be printed or etched into the different members of the tool 110. The measuring indicators 176 may also preferably be a contrasting color to the other members of the tool 110. Further, the measuring indicators 176 may have different lengths, thicknesses, or colors to allow easy distinction between marks and to divide the measuring indicators 176 into selective sub-units.

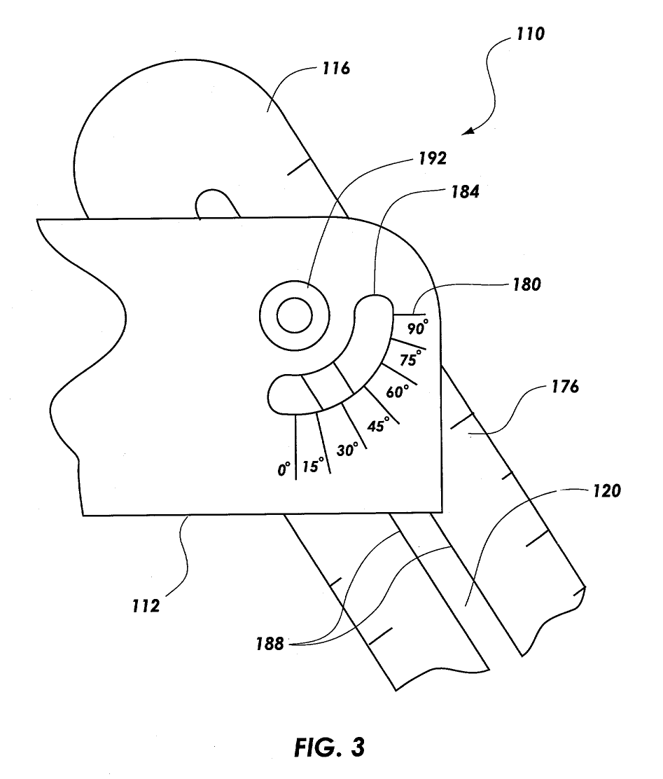

Referring now to FIG. 3, the tool 110 may also include angle indicators 180. The angle indicators 180 may be configured to define the relative positions of the arm 116 to the frame 112. In one embodiment, the angle indicators 180 are located on the frame 112 and may be accompanied by a window 184 in the frame 112. The window 184 may be an opening in the frame 112 that allows the arm 116 to be viewed through the frame 112 and aligned to the angle indicators 180. The angle indicators 180 may indicate a degree or pitch measurement. In one configuration, the frame has angle indicators 180 on each side of the frame. 112, where one side indicates degrees and the other side indicates pitch.

The arm 116 may align to the angle indicators 180 on the frame 112 in various configurations. For example, one of the edges 188 of the elongated slot 120 can be used as a reference to align the angle indicators 180, where the edge 188 of the elongated slot 120 lines up with one of the angle indicators 180. Alternatively, the two edges 188 of the elongated slot 120 may each align to different angle indicators 180. Such a configuration may be use if the angle indicators 180 become too compact together, making it difficult to read. A first half of the angle indicators 180 may be aligned to one edge 188 of the elongated slot 120 and a second half of the angle indicators 180 may be aligned to a second edge 188 of the elongated slot 120. Further, the different angle indicators 180 and the edges 188 of the elongated slot 120 may be color coded to distinguish between measuring alignments.

Another variation of the angle indicators 180 may include a reference mark on the arm 116 visible through the window 184. The reference mark could be aligned to the angle indicators 180 on the frame 112 to establish relative positions between the arm 116 and the frame 112. In yet another embodiment, the angle indicators 180 may be located on the arm 116 and visible through the window 184. The angle indicators 180 on the arm 116 may be alignable to a reference mark on the frame 112 adjacent to the window 184.

Referring to FIG. 2, the tool 110 may also include an arm clamping member 192 and a rule clamping member 196. The arm clamping member 192 and the rule clamping member 196 allow for the position and the orientation of the arm 116 and rule 156 to be fixed. The arm 116 and the rule 156 may be locked in selective measuring functions or alternatively, the arm 116 and the rule 156 may be locked once they are nested in the arm recess 144 and in the rule recess 172 respectively.

In the tool 110 illustrated in FIG. 2, the arm clamping member 192 and the rule clamping member 196 are comprised of a nut, such as a wing nut, threadably attached to a screw. The screws of the clamping members 192, 196 may be situated in the arm recess 144 and in the rule recess 172. When the nuts are rotated on the screws, the clamping members 192 reduce the opening size of the arm recess 144 and the rule recess 172. As the opening sizes of the recesses 144, 172 are reduced, sections of the frame 112 will pinch the arm 116 and the rule 156. Thus, the arm 116 and the rule 156 may be locked in place by the clamping members 192, 196.

Another variation of the arm clamping member 192 and the rule clamping member 196 may include a clamping device similar to a quick release mechanism used on a bicycle tire. The quick release mechanism has a bistable caming surface, where the mechanism may lock and unlock by simply pulling the lever. Such a mechanism may provide for rapid and secure locking and unlocking of the arm 116 and rule 156.

In another embodiment, the arm 116 and the rule 156 may not have clamping members 192, 196. Alternatively, the attachment of the arm 116 and the rule 156 to the frame 112 may have abutting surfaces with a plurality of corresponding peaks and valleys. As the arm 116 or rule 156 is rotated relative to the frame 112, the peaks will lift out of one valley, over a peak, and then drop into an adjacent valley. Thus, the orientation of the arm 116 and the rule 156 may be fixed by rotating either member until the peaks and valleys of the abutting surfaces lock the arm 116 or the rule 156 in the desired orientation.

By controlling the relative orientations of the arm 116 and the rule 156 with respect to the frame 112, a plurality of measuring configurations may be defined. In a first measuring configuration, the tool 110 may be used as a ruler. The tool 110 may have a measuring length equal to the length of the frame 112. Additionally, the length of the arm 116 may also be used as a ruler. As illustrated in FIG. 1, the arm 116 may be longer than the frame 112. The differences in lengths between the frame 112 and the arm 116 may allow for two different measuring lengths to select from when measuring an object.

In a second measuring configuration, the frame 112 and the arm 116 may be aligned end to end, such that the tool 110 has a length that is generally equal to the combined lengths of the frame 112 and the arm 116. Furthermore, the length that the arm 116 extends from the frame 112 may be adjusted by sliding the arm 116 into the arm recess 144, allowing the length of the tool 110 to be adjusted to multiple lengths.

In a third measuring configuration, the collapsible rule 156 may be unfolded and oriented such that the collapsible rule 156 is aligned end to end with the frame 112. Similar to previous embodiments, the length of the frame 112 and the length of the collapsible rule 156 may be combined to provide a measuring device that is longer than the arm 16 and frame 112.

In a fourth measuring configurations, the frame 112, the arm 116 and the collapsible rule 156 may be aligned end to end, such that the length of all three members is combined. As previously discussed, the length of the arm 116 may be adjusted to multiple lengths by sliding the arm 116 into the arm recess 144 of the frame 112. The tool 110 may then be used as a compass to draw a large arc, such as may be needed for a window cutout. The tool 110 may include holes 199 at the end of the arm 116 and at the end of the rule 156. The holes 199 can allow for a pivoting location of the compass configuration at one end and for a guiding location for marking an arc shape at the opposing end.

In a fifth configuration, the tool 110 may be used as a closed-angle finder. In the closed-angle finder configuration, the arm 116 is positioned relative to the frame 112, similar to the manner illustrated in FIG. 1. The frame 112 is then aligned to a first surface and the arm 116 is aligned to a second surface. The arm 116 may be locked relative to the frame 112 and the relative orientation may be identified by the indicators 180. Alternatively, when the arm 116 is fixed relative to the frame 112, the tool 110 may be used to trace the identified angle. In yet another embodiment of the fifth configuration, the frame 112 may not be aligned to a surface, but may rather be placed in a horizontal orientation by the horizontal bubble level 152. The arm 116 may then be adjusted to align to the angled or sloped surface, and the angle of the surface may be known relative to the horizontal reference established by the horizontal bubble level 152.

In a sixth configuration, the tool 110 may be used as a carpenter's square. The carpenter's square may be created by rotating the arm 116 to the first limit of rotation 124, such that the arm 116 abuts against the stop 128. In this configuration, the arm 116 is at 90° angle relative to the frame 112. The stop 128 allows the relative orientation between the arm 116 and the frame 112 to be accurately established. Additionally, the arm 116 may slide relative to the frame 112, such that one of the sides of the carpenter's square is adjustable to a large number of lengths.

In a seventh configuration, the arm 116 and the frame 112 may be aligned at a 90° orientation, such as with the carpenter's square. The collapsible rule 156 may then be extended, where the collapsible rule 156 aligns end to end with the frame 112. In such a configuration, the tool 110 may be used as a framing square. Additionally, by using the bubble levels 150, 152, 154 as a horizontal reference, the tool 110 may be used to make a stair cut for a large number of stair sizes.

In an eighth configuration, the tool 110 may be used as a pitch and degree finder. To function as a pitch and degree finder, the tool 110 may be positioned similar to the tool 110 illustrated in FIG. 2. To identify the pitch or degree, the arm 116 is first aligned to the angled surface that is desired to be known. Then the frame 112 is pivoted relative to the arm 116 until the vertical bubble level 154 (situated in a horizontal orientation) establishes a horizontal reference. The arm 116 may then be locked relative to the frame 112 and the angle or pitch may be determined from the angle indicators 180.

In a ninth configuration, the tool 110 may be used to create a ridge cut and plum cut. The ridge cut and plum cut configurations may be created by aligning the tool 110 similar to that shown in FIG. 2. The arm 116 is aligned to a pitch or angle reference of the angle indicators 180. The pitch or angle at which the arm 116 is placed will correspond to the pitch or angle of the structure, such as a roof, that is receiving the ridge cut or the plum cut. The frame 112 may then be aligned against the angled or sloped structure, such that the arm 116 is in a vertical orientation. The vertical orientation may then be marked and the ridge cut or plum cut may be made.

The versatility of the present tool allows for other configurations not specifically described herein. These other configurations may be accomplished by orienting the arm and the collapsible rule in various positions relative to the frame. While various features of the tool have been described herein, the tool may be broadly described as an arm that is rotatably and slidably attach to a frame, that are alignable to a plurality of measuring configurations.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed and desired to be secured by United States Letters Patent is:

1. A multi-configurational tool comprising:
a frame having a first end and a second end; and
an arm rotatably and slidably coupled to the first end of the frame, wherein the frame and the arm are adjustable to define a plurality of measuring configurations.

2. The multi-configurational carpentry tool, as recited in claim 1, further comprising a collapsible rule coupled to the second end of the frame.

3. The multi-configurational carpentry tool, as recited in claim 2, wherein the frame further comprises a rule recess, wherein the collapsible rule is nestable within the rule recess.

4. The multi-configurational carpentry tool, as recited in claim 1, further having at least one bubble level within the frame.

5. The multi-configurational carpentry tool, as recited in claim 4, wherein the frame has a horizontal bubble level, a vertical bubble level, and a 45° bubble level.

6. The multi-configurational carpentry tool, as recited in claim 1, wherein the frame and the arm have a plurality of measuring indicators.

7. The multi-configurational carpentry tool, as recited in claim 1, wherein the arm has an elongated slot, and wherein the arm is coupled to the frame by a mounting pin that is positioned in the elongated slot.

8. The multi-configurational carpentry tool, as recited in claim 1, wherein the frame has a stop to limit the rotation of the arm.

9. The multi-configurational carpentry tool, as recited in claim 1, wherein the frame further comprises a plurality of angle indicators, wherein the angle indicators indicate the orientation of the arm relative to the frame.

10. The multi-configurational carpentry tool, as recited in claim 1, wherein the frame further comprises an arm recess, and wherein the arm is at least partially nestable into the arm recess.

11. The multi-configurational carpentry tool, as recited in claim 1, wherein the orientation of the arm is fixable by a clamping mechanism.

12. A tool that is adjustable to define a plurality of measuring configurations comprising:
a frame having a first end and a second end;
at least one bubble level located within the frame;
an arm rotatably and slidably coupled to the first end of the frame; and
a rule rotatably coupled to the second end of the frame.

13. The multi-configurational carpentry tool, as recited in claim 12, wherein the rule has at least one folding pivot along its length.

14. The multi-configurational carpentry tool, as recited in claim 12, wherein the frame further comprises a rule recess, wherein the collapsible rule is at least partially nestable within the rule recess.

15. The multi-configurational carpentry tool, as recited in claim 12, wherein the carpentry tool has a horizontal bubble level, a vertical bubble level, and a 45° bubble level.

16. The multi-configurational carpentry tool, as recited in claim 12, wherein the frame and the arm have a plurality of measuring indicators.

17. The multi-configurational carpentry tool, as recited in claim 12, wherein the arm has an elongated slot, and wherein the arm is coupled to the frame by a mounting pin that is positioned in the elongated slot.

18. The multi-configurational carpentry tool, as recited in claim 12, wherein the frame has a stop to limit the rotation of the arm.

19. The multi-configurational carpentry tool, as recited in claim 12, wherein the frame further comprises a plurality of angle indicators, wherein the angle indicators indicate the orientation of the arm relative to the frame.

20. The multi-configurational carpentry tool, as recited in claim 12, wherein the frame further comprises an arm recess, and wherein the arm is at least partially nestable into the arm recess.

21. The multi-configurational carpentry tool, as recited in claim 12, wherein the orientation of the arm is fixable by a clamping mechanism.

22. A tool that is adjustable to define a plurality of measuring configurations comprising:
an arm having an elongated slot and having a plurality of measuring indicators;
a frame having a plurality of measuring indicators, wherein the frame has a mounting pin that is positioned within the elongated slot of the arm;
at least one bubble level located within the frame; and
a collapsible rule rotatably coupled to the frame and having a plurality of measuring indicators.

23. The multi-configurational carpentry tool, as recited in claim 12, wherein the frame further comprises a rule recess, and wherein the collapsible rule is at least partially nestable within the rule recess.

24. The multi-configurational carpentry tool, as recited in claim 12, wherein the frame further comprises an arm recess, and wherein the arm is at least partially nestable into the arm recess.
